(19) United States
(12) Patent Application Publication
(10) Pub. No.: US 2018/0079105 A1
(43) Pub. Date: Mar. 22, 2018

(54) Magnetic composite structure by magnet-based cold molding method

(71) Applicant: Kang Yao, Delray Beach, FL (US)

(72) Inventor: Kang Yao, Delray Beach, FL (US)

(73) Assignee: AMERICAN MAGNETIC ENGINEERING, INC., DELRAY BEACH, FL (US)

(21) Appl. No.: 15/267,992

(22) Filed: Sep. 16, 2016

(51) Int. Cl. B28B 1/16

(52) U.S. Cl. CPC B28B 1/16

(57) ABSTRACT

The present invention relates to a highly new method of magnet-based cold molding to make magnetic composite structure. According to the process of this invention, the magnetic composite structure can be efficiently made into molded products with great magnetic and physical strength. This method can greatly reduce the cost and lead time of making the magnetic composite structure. It also reduces the impact on environment since the magnet-based cold molding differs from other traditional method such as the plastic-molding or casting mold, which destroys the magnetism of the magnets and pollutes the environment.

### BACKGROUND OF THE INVENTION

Magnets are playing an important role in many facets of our lives. Many times magnets are integrated with other material to serve as one module. In all of these uses, it is expected to generate as much magnetism as possible. For most part, the strength of a magnet is directly proportional to its size. Magnet-based cold molding is a method in which the magnetic composite structure can be made with great strength at relatively low cost and lead time. This method can be widely used in making magnetic modules for construction industry, motor assembly, and bio-medical equipment etc.

CN203013460 U discloses a transformer magnetic core with soft magnetism concrete materials. This soft magnetism concrete material consists of magnetic iron power, cement. They mix them well with ratio of 2:1, then epoxy iron powder and cement fully bonded into one, finally compact and cool to produce the soft concrete material. EP0557368 A1 discloses a conventional mixture powder which comprises the particles of a magnetic and a sub composition, such as cement particles. They mix all of those particles with water to produce the magnetic composition body. According to prior art, this kind of composition is limit to its shape, size and magnetic strength due to the dimensional limit of the charging cavity of the magnetizing unit. Our invention is a new method to make the magnetic module of any shape and size by molding the permanent magnet into the composite material. This method of manufacturing is simple, low cost and can effectively improve the surface magnetism of the product.

### SUMMARY OF THE INVENTION

The invention is a highly new method of making powerful magnet-based composite structure for concrete material and magnetic separation, etc. The magnet-based composite structure is composed of permanent magnets, iron or steel and molding material, such as cement, paste, powder mixture etc.

It performs the function of a magnetic module with a high integrated strength due to its composite structure. The cold molding material acts as the binding agent for the magnet and the composite structure. The iron or steel metal is used to attach the magnet and embedded in the molding material to form the composite structure. It acts as a reinforcement conjunction which improves the physical strength of the composite structure. It also improves the magnetic efficiency by reflecting the magnetism from one side onto the other side which is the working side. Thus, the composite structure achieves a maximum magnetism on the working surface. Prior to our invention, the high cost of manufacturing such a powerful magnet module could deter many potential users. Our new method of magnet-based cold molding solves this problem with reliability and cost-efficiency. The traditional plastic molding is subject to high temperature, under which the permanent magnet will lose its magnetism. Our magnet-based cold molding method solves this problem by combing the magnet and the molding material at room temperature, i.e., cold molding.

From the FIG. 1 and FIG. 2, the magnetic concrete brick made by magnet-based cold molding method can be used as construction materials in a vast area of applications, including in the special environment. The magnetic brick can be quickly assembled using its magnetic attraction. This can be done without traditional cement and paste, thus making it possible to setup a temporary building in harsh environment such as the arctic conditions where the sub-zero freezing temperature prohibits the use of regular concrete material. Also magnetic brick via magnet-based cold molding method can be applied in the magnetic gardening, thus eliminates the need to use the pesticide since its magnetic field repels the bug away naturally. During the growth process of the plant, the magnetic field is steadily acting on living systems and can facilitate it healthy growth. It is indeed a green environmental factor for the organic farming.

From the FIG. 3 to FIG. 4, magnet-based cold molding are used in the conduit segment of underground water pipe to filter out the unwanted metal particles in the water supply. This application in the water system can be help improve the water quality and hence people's health in many regions especially in the developing countries due to its simplicity and cost efficiency in manufacturing. As seen in FIG. 5 and FIG. 6, we can also make the bio-medical magnetic separation device by using the magnet-based cold molding method. The powerful mag-slab is made using magnet-based cold molding method, then it is assembled into the separation device for magnetic separation of the target cell or molecule in bio-medical lab.

### REFERENCE

1. CN203013460 U, Oct. 18, 2012-Jun. 19, 2013. Yanshan University, Transformer magnetic core with soft magnetism concrete materials.
2. EP0557368 A1, Nov. 12, 1991-May 29, 1992. Aalborg Portland As, Magnetic cement-bound bodies.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a perspective view of a magnetic brick structure by magnet-based cold molding method.

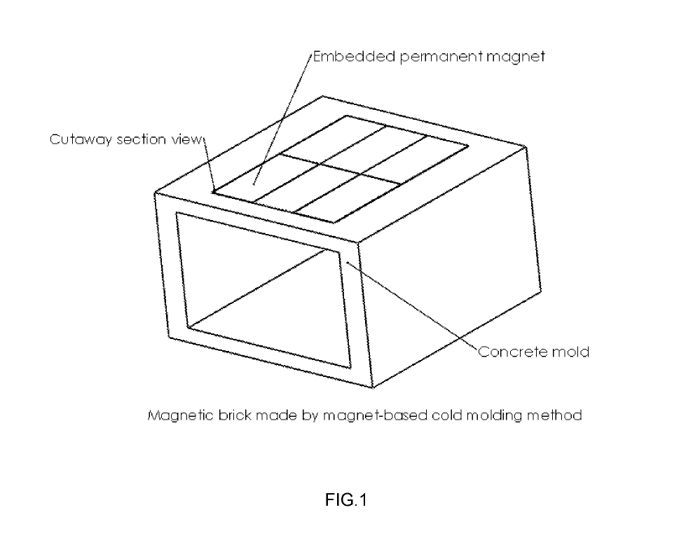

FIG. 2 shows a perspective view of bonding test of magnetic brick sample by magnet-based cold molding method.

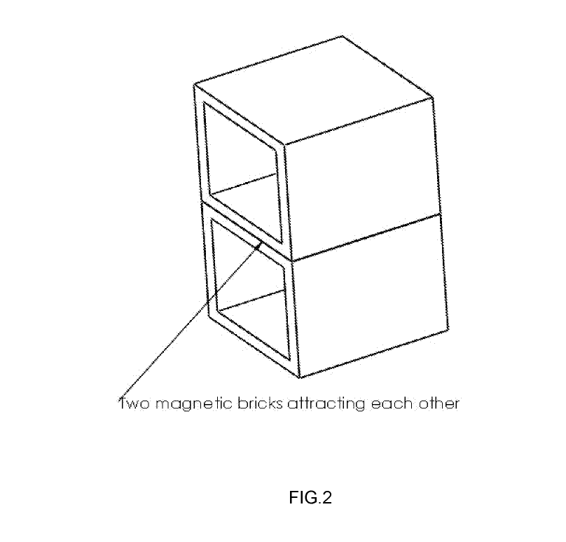

FIG. 3 shows a perspective view of magnet layout in a composite structure before the module formation via magnet-based cold molding method.

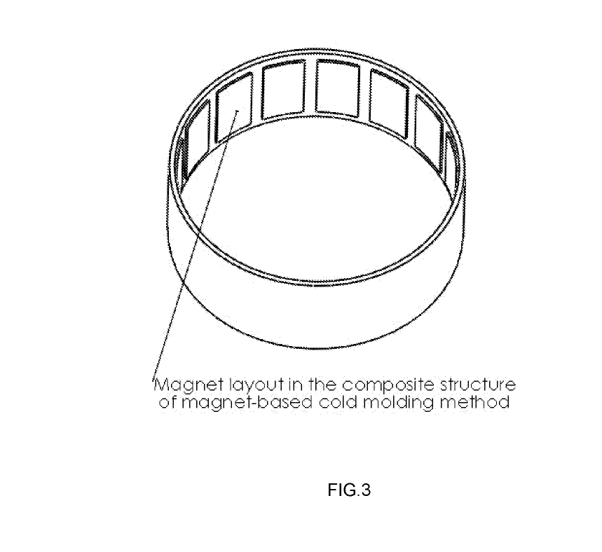

FIG. 4 shows conduit segment of underground water pipe system by magnet-based cold molding method.

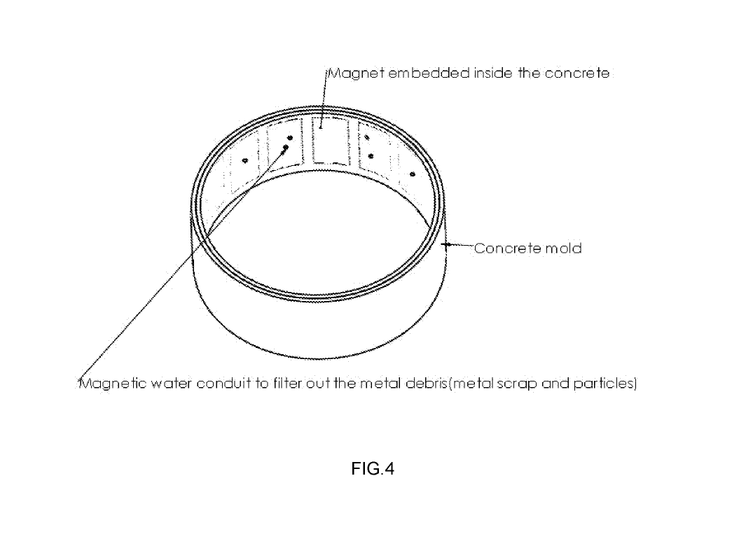

FIG. 5 shows a perspective view of a mag-slab prior to its formation via magnet-based cold molding method.

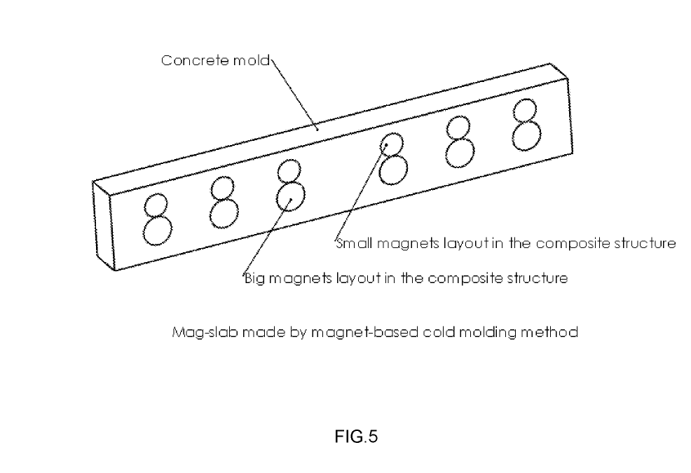

FIG. 6 shows a perspective view of the magnetic separator.

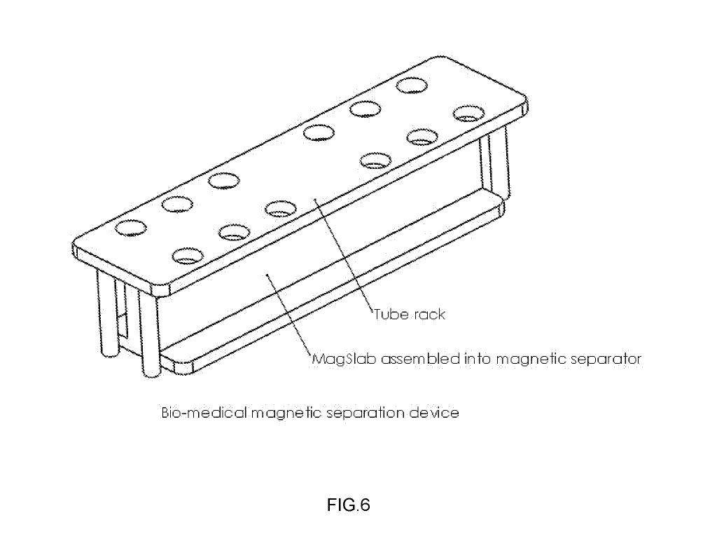

What is claimed is:

1. A highly new method of the magnet-based cold molding comprising:
Making a mold of any shape and dimension;
Attaching the magnets onto the iron or steel;
Placing the above magnet-attached iron or steel into the mold;
Mixing the molding materials defined in claim 3 with water well;
Pouring the above ready mixture of molding materials into the mold and forming an integrated composite structure.

2. The method of any of claim 1, wherein the magnets are permanent magnets of any shape and dimension.

3. The method of any of claim 1, wherein the molding material is cement, paste, powder mixture or other mortar material as long as it can be molded at room temperature.
